(19) United States
(12) Patent Application Publication
(10) Pub. No.: US 2015/0302569 A1
(43) Pub. Date: Oct. 22, 2015

(54) SENSING SYSTEM FOR A COOKTOP APPLIANCE WITH AIRFLOW PROTECTED SENSOR

(71) Applicant: General Electric Company, Schenectady, NY (US)

(72) Inventors: James Lee Armstrong, Louisville, KY (US); Joshua Stephen Wiseman, Elizabethtown, KY (US); Li Guan, Clifton Park, NY (US)

(73) Assignee: General Electric Company, Schenectady, NY (US)

(21) Appl. No.: 14/258,071

(22) Filed: Apr. 22, 2014

(51) Int. Cl. G06T 7/00; F04D 15/00

(52) U.S. Cl. CPC G06T 7/0002; F04D 15/0066

(57) ABSTRACT

The present invention provides for operation of a sensor supported by an appliance and directed toward a cooking surface positioned beneath the sensor. If the sensor is determined to be contaminated, a signal is provided to a user of the appliance that the sensor is contaminated.

### FIELD OF THE INVENTION

The subject matter of the present disclosure relates generally to methods and systems for monitoring the cooktop of an oven range appliance.

### BACKGROUND OF THE INVENTION

Over-the-range microwave appliances are generally mounted above a cooktop of an oven range appliance. Conventionally, cooktop appliances have been largely dependent upon a user monitoring the cooktop during use to determine, e.g., whether a pot of water is boiling or if a spill-over has occurred. There may be times, however, when a user may not be able to monitor the cooktop during use. Accordingly, a sensor may be contained in a sensor housing mounted over the range, e.g., on an over-the-range microwave appliance, to monitor the cooktop positioned beneath the sensor.

However, a sensor mounted above the cooktop could become contaminated by, e.g., grease and moisture generated during use of the cooktop. A build-up of contaminants on, e.g., the sensing end of the sensor could impede the ability of the sensor to sense the cooktop. Thus, the sensor generally should be cleaned periodically or when contaminants have built up on the sensor. Currently, however, consumers do not receive any feedback that the sensor may require cleaning. Thus, some consumers may wait too long to clean the sensor or neglect to clean the sensor at all.

Accordingly, a sensor system with features for signaling to a user a need to clean the sensor would be beneficial. A system incorporated into an appliance, such as e.g., microwave appliance, would be useful.

### BRIEF DESCRIPTION OF THE INVENTION

The present invention provides for operation of a sensor supported by an appliance and directed toward a cooking surface positioned beneath the sensor. If the sensor is determined to be contaminated, a signal is provided to a user of the appliance that the sensor is contaminated. Additional aspects and advantages of the invention will be set forth in part in the following description, may be apparent from the description, or may be learned through practice of the invention.

In a first exemplary embodiment, a method is provided for operating the sensor. The method includes employing the sensor to obtain a current image of the cooking surface; comparing the current image to a baseline image; determining, from the step of comparing, whether the sensor is contaminated and, if so, then providing a signal to indicate sensor contamination to a user of the appliance.

In a second exemplary embodiment, a method is provided for operating the sensor. The method includes activating the sensor; detecting whether a cooking utensil is on the cooking surface and, if so, then operating a sensor fan configured to blow air past the sensing end of the sensor. The method further includes counting the total operation time tₜₒₜ of the sensor fan and providing a signal that the sensor requires cleaning when the total operation time tₜₒₜ reaches at least a threshold value tₜₕᵣ.

In a third exemplary embodiment, an appliance is provided. The appliance includes a sensor having a sensing end, the sensing end downwardly directed toward a cooking surface of the appliance; a sensor fan configured for creating a flow of air past the sensing end; and a controller in operative communication with the sensor and the sensor fan. The controller is configured for employing the sensor to obtain a current image of the cooking surface; comparing the current image to a baseline image; determining, from the step of comparing, whether the sensor is contaminated and, if so, then providing a signal to indicate sensor contamination to a user of the appliance.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of a microwave appliance according to an exemplary embodiment of the present subject matter mounted to a kitchen cabinet above an oven range appliance.

FIG. 2 provides a side, section view of an exemplary microwave appliance and oven range appliance in accordance with one exemplary embodiment of the present disclosure.

FIG. 3 provides a side, section view of an exemplary microwave appliance and oven range appliance in accordance with another exemplary embodiment of the present disclosure.

FIG. 4 provides a section view of an exemplary sensor system of the present disclosure.

FIG. 5 provides a section view of an alternative exemplary embodiment of the sensor system of the present disclosure.

FIG. 6 provides a section view of an alternative exemplary embodiment of the sensor system of the present disclosure.

FIG. 7 provides a section view of another alternative exemplary embodiment of the sensor system of the present disclosure.

FIG. 8 illustrates a method of operating a sensor in accordance with one exemplary embodiment of the present subject matter.

FIG. 9 illustrates a method of operating a sensor in accordance with another exemplary embodiment of the present subject matter.

FIG. 10 illustrates a method of operating a sensor in accordance with another exemplary embodiment of the present subject matter.

FIG. 11 illustrates a method of operating a sensor in accordance with another exemplary embodiment of the present subject matter.

FIG. 12 illustrates a method of operating a sensor in accordance with another exemplary embodiment of the present subject matter.

Use of the same reference numerals in different figures denotes the same or similar features.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

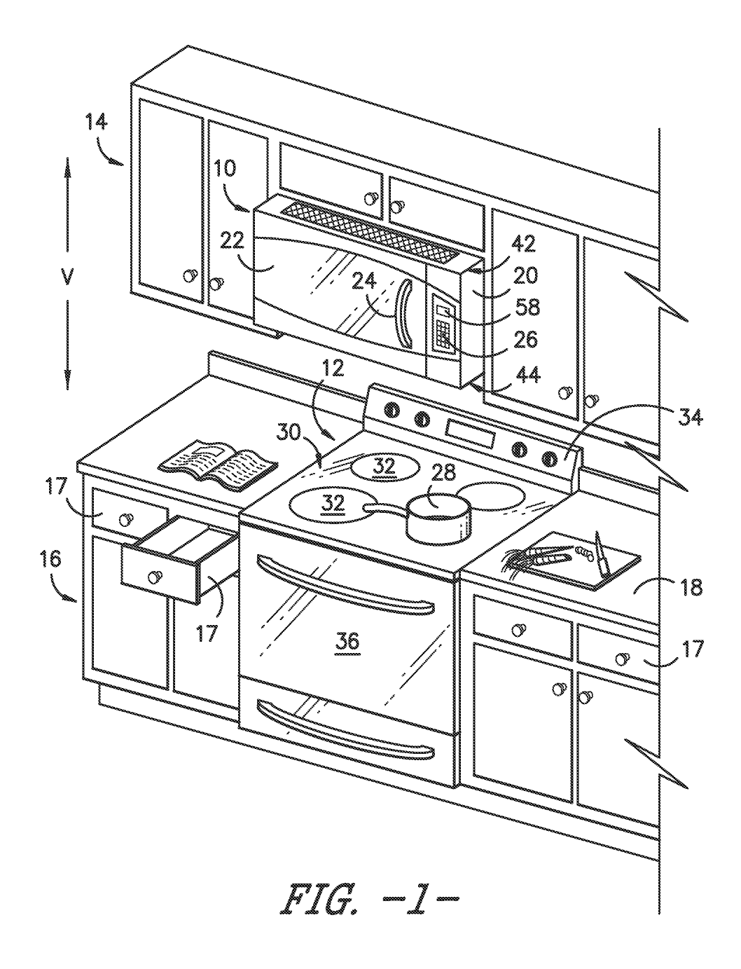

FIG. 1 provides a perspective view of a microwave appliance 10 according to an exemplary embodiment of the present subject matter mounted to an upper set of kitchen cabinets 14 above an oven range appliance 12, e.g., along a vertical direction V. Microwave appliance 10 shown in FIG. 1 is commonly referred to as an over-the-range microwave. It should be understood that, in alternative embodiments, the present subject matter may be used in any other suitable appliance, such as, e.g., a range hood, or may be used with a sensor positioned over the cooktop.

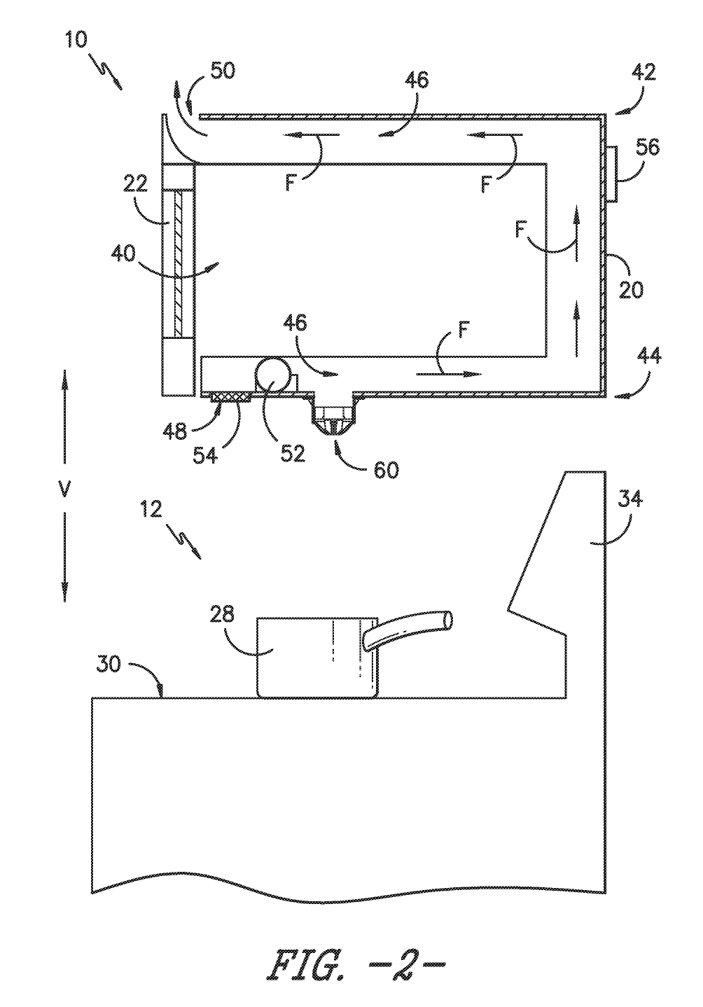

Upper set of kitchen cabinets 14 is positioned above a base set of kitchen cabinets 16, e.g., along the vertical direction V. Base set of kitchen cabinets 16 includes countertops 18 and drawers 17. Oven range appliance 12 is received within base set of kitchen cabinets 16 below microwave appliance 10. In particular, a cooking surface 30 of oven range appliance 12 is positioned, e.g., directly, below microwave appliance 10 along the vertical direction V. Microwave appliance 10 can include features such as an air handler or fan 52 (FIG. 2) that can draw cooking vapors and/or smoke away from cooking surface 30 and out of the kitchen containing microwave and oven range appliances 10 and 12.

Microwave appliance 10 is configured for receipt of food items for cooking. In particular, microwave appliance 10 includes a cabinet or casing 20 and a door 22 that permits selective access to an interior of microwave appliance 10 and casing 20. Door 22 includes a handle 24 that a user can pull to open door 22 to insert food items into microwave appliance 10. Microwave appliance 10 also includes controls 26 that permit a user to make selections for cooking of food items, e.g., a duration of a cooking cycle of microwave appliance 10 and/or a power setting for the cooking cycle of microwave appliance 10.

Oven range appliance 12 includes cooking surface 30. Cooking surface 30 includes heated portions 32 that may be heated by heating elements (not shown), e.g., electrical resistive heating elements, gas burners, induction heating elements, and/or any other suitable heating element or combination of heating elements. Oven range appliance 12 also includes a door 36 that permits access to a heated compartment (not shown) of oven range appliance 12, e.g., for cooking or baking of food items therein. A control panel 34 of oven range appliance 12 can permit a user to make selections for cooking of food items, e.g., a duration of a cooking cycle of oven range appliance 12 and/or a power setting for the cooking cycle of oven range appliance 12.

FIG. 2 provides a side, section view of microwave appliance 10 and oven range appliance 12. As illustrated, casing 20 extends between a top portion 42 and a bottom portion 44, e.g., along the vertical direction V. Thus, top and bottom portions 42 and 44 of casing 20 are spaced apart from each other, e.g., along the vertical direction V. Casing 20 defines a cooking chamber 40 configured for receipt of food items for cooking. Door 22 of microwave appliance 10 permits selective access to cooking chamber 40 of casing 20. In particular, door 22 of microwave appliance 10 is selectively adjustable between an open position (not shown) and a closed position (FIGS. 1 and 2). In the closed position, door 22 of microwave appliance 10 hinders access to cooking chamber 40 of casing 20. Conversely, door 22 of microwave appliance 10 permits access to cooking chamber 40 of casing 20 in the open position. A user can pull on handle 24 of door 22 of microwave appliance 10 in order to shift door 22 from the closed position shown in FIG. 2 to the open position.

Casing 20 also defines a cooling air pathway or conduit 46. Pathway 46 has an inlet 48 and an outlet 50. Pathway 46 extends between inlet 48 and outlet 50. Inlet 48 of pathway 46 is positioned at or adjacent bottom portion 44 of casing 20, e.g., such that inlet 48 of pathway 46 faces cooking surface 30 of oven range appliance 12. Conversely, outlet 50 of pathway 46 is positioned at or adjacent top portion 42 of casing 20, e.g., such that outlet 50 of pathway 46 faces away from cooking surface 30 of oven range appliance 12. Outlet 50 could face in other direction as well, although preferably not toward cooking surface 30. Thus, inlet 48 and outlet 50 of pathway 46 are spaced apart from each other, e.g., along the vertical direction V.

Microwave appliance 10 also includes a cooling fan 52, such as an axial fan or a radial fan. Fan 52 is positioned within or adjacent pathway 46. Fan 52 draws or urges a flow of air (shown with arrows F) through pathway 46 when fan 52 is in an activated state. Conversely, fan 52 does not draw or urge flow of air F through pathway 46 when fan 52 is in a deactivated state. When fan 52 is in the activated state, flow of air F enters pathway 46 at or through inlet 48 of pathway 46. Flow of air F is directed through pathway 46 to outlet 50, and flow of air F can exit pathway 46 at outlet 50 of pathway 46.

As may be seen in FIG. 2, microwave appliance 10 may further include a controller 56. Operation of microwave appliance 10 may be regulated by controller 56. Controller 56 is operatively coupled or in communication with various components of microwave appliance 10, including controls 26. In response to user manipulation of controls 26, controller 56 operates the various components of microwave appliance 10 to execute selected cycles and features.

Controller 56 may include a memory and microprocessor, such as a general or special purpose microprocessor operable to execute programming instructions or micro-control code associated with a cleaning cycle. The memory may represent random access memory such as DRAM, and/or read only memory such as ROM or FLASH. In one embodiment, the processor executes programming instructions stored in memory. The memory may be a separate component from the processor or may be included onboard within the processor. Alternatively, controller 56 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Controls 26 and other components of microwave appliance 10 may be in communication with controller 56 via one or more signal lines or shared communication busses.

Controller 56 may also be in operative communication with cooling air fan 52. Thus, controller 56 can selectively adjust cooling fan 52 between the activated and deactivated states to regulate the flow of air F through pathway 46.

Additionally, microwave appliance 10 may support a sensor system 60 such that cooking surface 30 is positioned beneath sensor system 60. Sensor system 60 includes a sensor 62 for monitoring cooking surface 30 and any cooking utensils containing food items for cooking, such as, e.g., cooking utensil 28, on cooking surface 30. More particularly, sensor 62 is configured, e.g., to detect whether a cooking utensil is present on cooking surface 30 and, if so, to provide a signal indicative of the same to controller 56. Sensor 62 may also be equipped with other features such as, e.g., the ability to determine (and provide a signal indicative of) the temperature of the cooktop, a utensil placed on the cooktop, and/or food present on the cooktop. Sensor 62 may be an optical sensor or any other sensor suitable for monitoring cooking surface 30. Further, sensor 62 may be in operative communication with controller 56, which may output an indicator signal to, e.g., a controls display 58 of microwave appliance 10 or another suitable source to alert a user to the status of cooking surface 30 or food items within cooking utensils 28 on cooking surface 30.

As shown in FIG. 2, sensor system 60 is in fluid communication with pathway 46. More particularly, air flowing through pathway 46 also causes air to flow through sensor system 60 as will be further described.

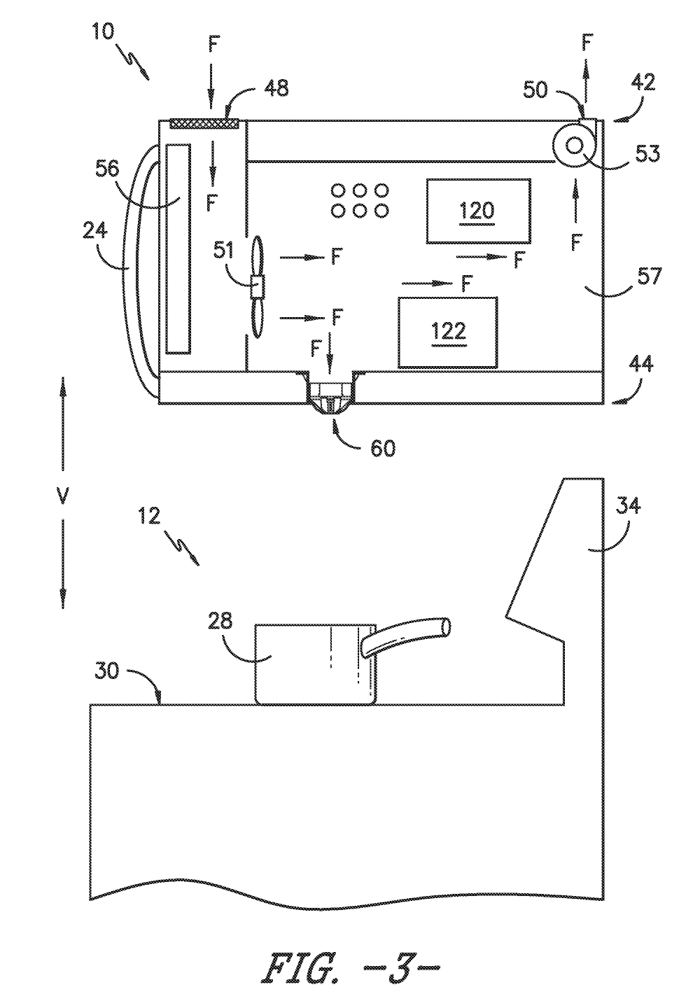

It should be understood that, in alternative embodiments, sensor system 60 could be positioned at other locations on microwave appliance 10 or could be supported by any other suitable appliance or surface, such as, e.g., a range hood or upper cabinets 14. As an example, in the exemplary embodiment illustrated in FIG. 3, microwave appliance 10 includes a microwave fan 51 that creates a flow of air F through the controls compartment 57, in which controller 56 is positioned. More particularly, microwave fan 51 draws air through inlet 48 and past controller 56, magnetron 120, and power supply 122. Additionally, an exhaust fan 53 draws or urges air flow F to exit controls compartment 57 through outlet 50. Sensor system 60 is in fluid communication with controls compartment 57 such that air flowing through controls compartment 57 also causes air to flow through sensor system 60 as will be described. Other configurations of microwave appliance 10 and sensor system 60 may also be used, or sensor system 60 could be supported by any other suitable appliance or surface.

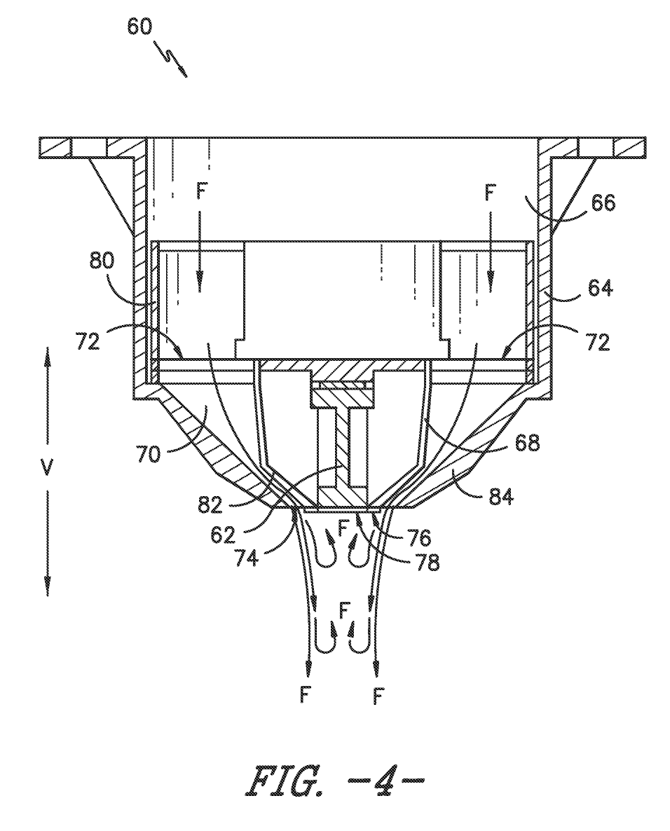

Referring now to FIG. 4, in an exemplary embodiment, sensor 62 of sensor system 60 is contained within an inner housing 68 that is positioned within an outer housing 64. Outer housing 64 defines a chamber 66 that is in fluid communication with pathway 46. Inner housing 68 is positioned within chamber 66 such that inner housing 68 and outer housing 64 define a channel 70 for a flow of air F. Moreover, the inner housing defines a sensor aperture 76, and the sensing end 78 of sensor 62 is positioned at the sensor aperture 76. Sensor aperture 76 may be open or may have a protective covering such as, e.g., a glass lens.

The channel 70 has a channel inlet 72 positioned downstream of cooling fan 52 and in fluid communication with chamber 66 to receive a flow of air F from pathway 46. Further, channel 70 has a channel outlet 74 from which the flow of air F flows past the sensing end 78 of sensor 62. The flow of air F acts to protect the sensing end 78 by blowing away, e.g., moisture, grease, or other contaminants generated during use of the cooking surface 30 that might otherwise block or impede the proper operation of sensor 62.

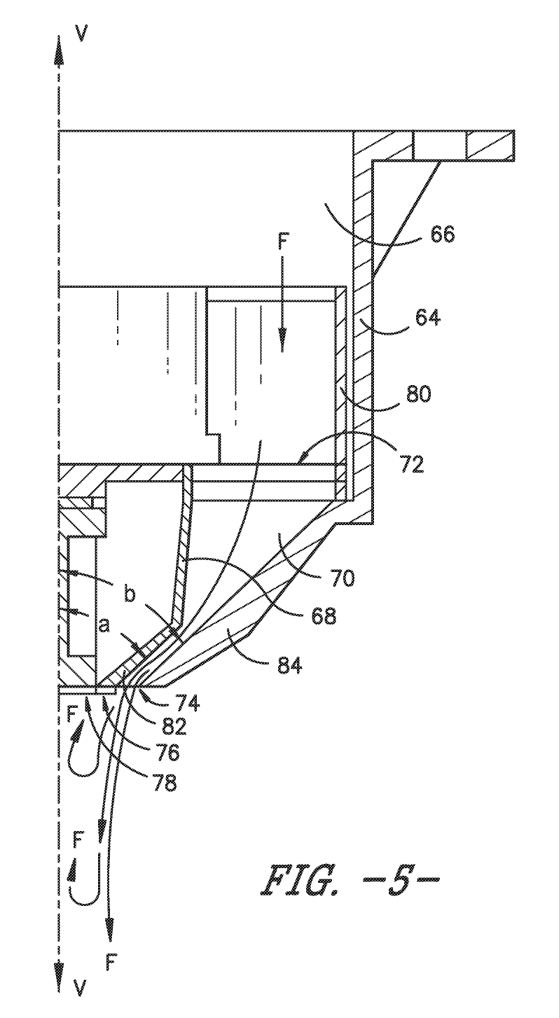

As illustrated in FIG. 5, channel 70 may be defined by an angled inner portion 82 of inner housing 68 and an angled outer portion 84 of outer housing 64. Angled inner portion 82 is positioned at an angle α with respect to the vertical direction and angled outer portion 84 is positioned at an angle β with respect to the vertical direction. Angled inner portion 82 and angled outer portion 84 direct the flow of air F past the sensing end 78 of sensor 62 to keep the sensing end 78 free from contamination. In one exemplary embodiment, angles α and β are in a range of about 30 to about 60 degrees. In still another embodiment, angles α and β are about 45 degrees. Other values for angles α and β may be used as well.

As shown in FIGS. 4 and 5, in certain embodiments of the invention, a sensor fan 80 is positioned within chamber 66 of outer housing 68 adjacent channel inlet 72. Sensor fan 80 may be used in addition to fan 52 to create air flow F or may be used instead of fan 52 to create air flow F. The sensor fan 80 is in operative communication with controller 56 and is configured to create a flow of air F through channel 70 and past sensing end 78 of sensor 62 to keep the sensing end 78 free from contamination. Sensor fan 80 may be used in addition to an air flow created by fan 52 or may be used separately from the operation of fan 52. Alternatively, where sensor system 60 is not mounted onto another appliance such a microwave 10 having a fan for air flow, sensor fan 80 can be used to provide the proper air flow F.

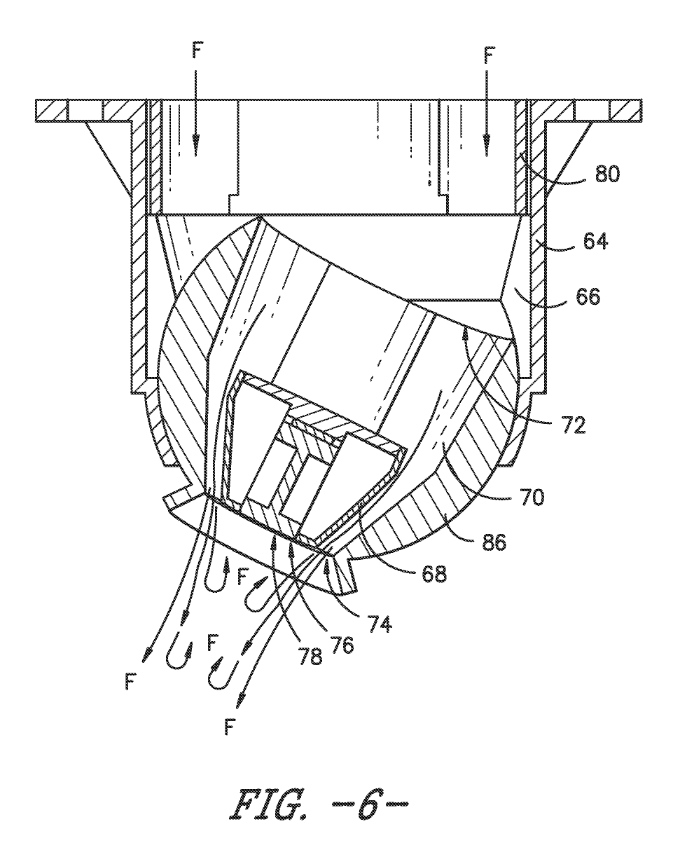

Referring now to FIG. 6, which uses the same reference numerals to denote the same or similar features, in another exemplary embodiment of the invention, the sensor system 60 includes a rotatable housing 86 positioned within chamber 66 of outer housing 64. In this embodiment, inner housing 68 is positioned within rotatable housing 86. Rotatable housing 86 is manually rotatable such that a user of the microwave appliance 10 may position the sensing end 78 of sensor 62 in a desired position.

Further, rotatable housing 86 and inner housing 68 define channel 70 for the flow of air F. Channel inlet 72 of channel 70 is positioned downstream of cooling fan 52 to receive a flow of air F from pathway 46 such that air flows out of channel outlet 74 and past sensing end 78. In yet another embodiment, sensor system 60 includes a sensor fan 80 in operative communication with controller 56 and positioned in chamber 66 adjacent channel inlet 72 to create a flow of air F through channel 70 and past sensing end 78. Sensor fan 80 may be used in addition to an air flow created by fan 52 or may be used separately from the operation of fan 52. Alternatively, where sensor system 60 is not mounted onto another appliance such a microwave 10 having a fan for air flow, sensor fan 80 can be used to provide the proper air flow F.

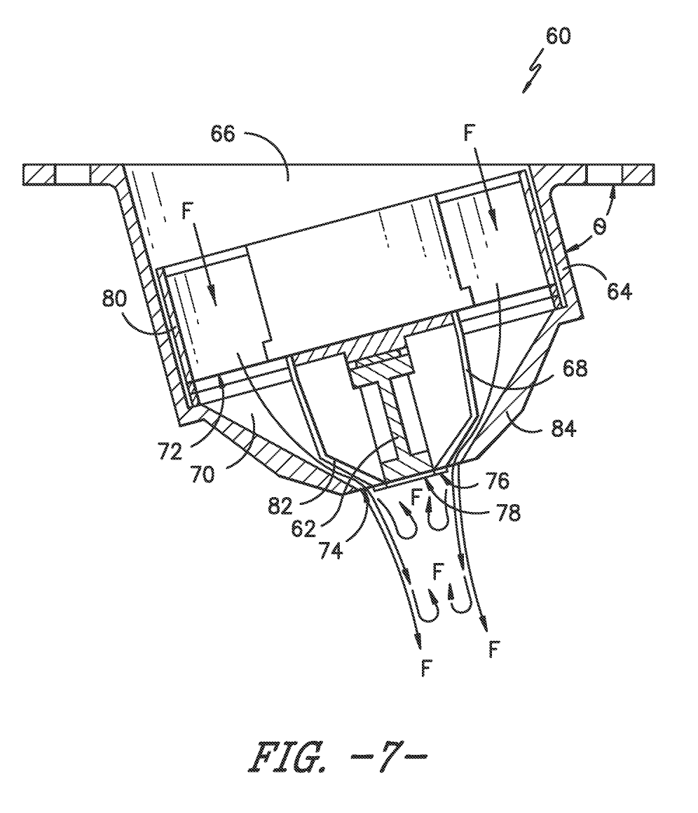

As shown in FIG. 7, which uses the same reference numerals to denote the same or similar features, in still other exemplary embodiments of the invention, the sensor system 60 may be angled with respect to the microwave appliance. More particularly, outer housing 64 is positioned at a non-orthogonal angle θ with respect to the lower portion 44 of microwave appliance 10. In one exemplary embodiment, angle θ is in a range of about 30 to about 60 degrees. In still another embodiment, angle θ is about 45 degrees. Other values for angle θ may be used as well.

Further, as illustrated in FIG. 7, inner housing 68 is positioned within chamber 66 of outer housing 64 such that inner housing 68 and outer housing 64 define channel 70 to direct a flow of air F past the sensing end 78 of sensor 62. Channel 70 includes channel inlet 72 positioned downstream from cooling fan 52 to receive a flow of air from pathway 46. Alternatively, or in addition thereto, sensor fan 80 may be in operative communication with controller 56 and may be positioned within chamber 66 adjacent channel inlet 72 to provide a flow of air F through channel 70 and past sensing end 78.

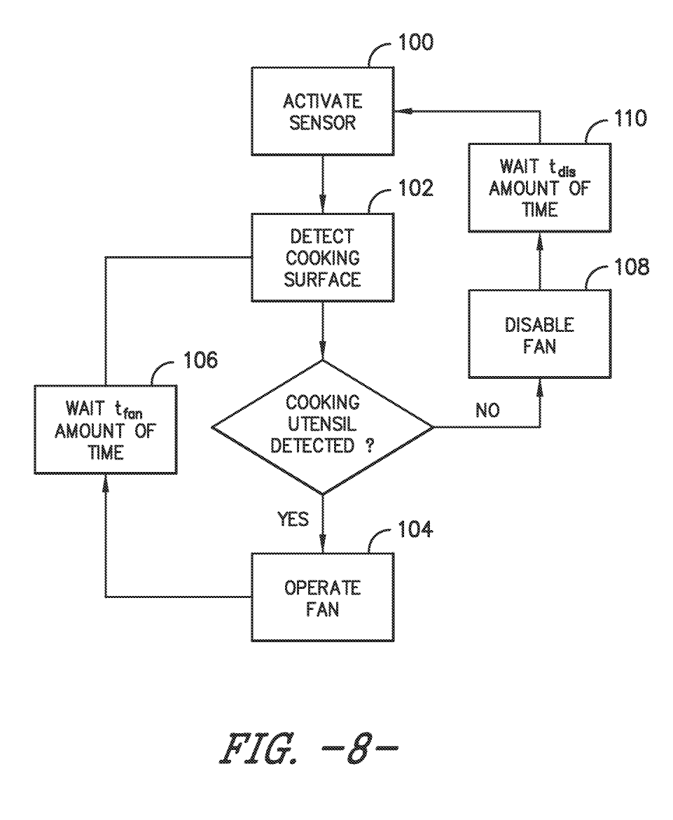

Referring now to FIG. 8, the present disclosure is further directed to methods for operating sensor 62. A method may include, for example, the step 100 of activating sensor 62 with controller 56, and the step 102 of detecting the cooking surface 30 to determine if a cooking utensil 28 is on cooking surface 30, as discussed above. Step 102 may be performed by the controller 56, e.g., by running a detecting algorithm. If a cooking utensil 28 is detected on cooking surface 30, the method includes the step 104 of operating fan 52 to provide a flow of air F through channel 70 and past sensing end 78 of sensor 62, as discussed above. The method includes step 106 of waiting a programmed period of time t_{fan}. Step 102 may be repeated after step 106 to determine if the cooking utensil is still on cooking surface 30. If no cooking utensil 28 is detected on cooking surface 30, the method includes the step 108 of disabling fan 52 and the step 110 of waiting a programmed period of time t_{dis} before reactivating sensor 62 to determine if a cooking utensil is present. In alternative embodiments, the method may include operating and disabling fans 51 and 53 rather than fan 52.

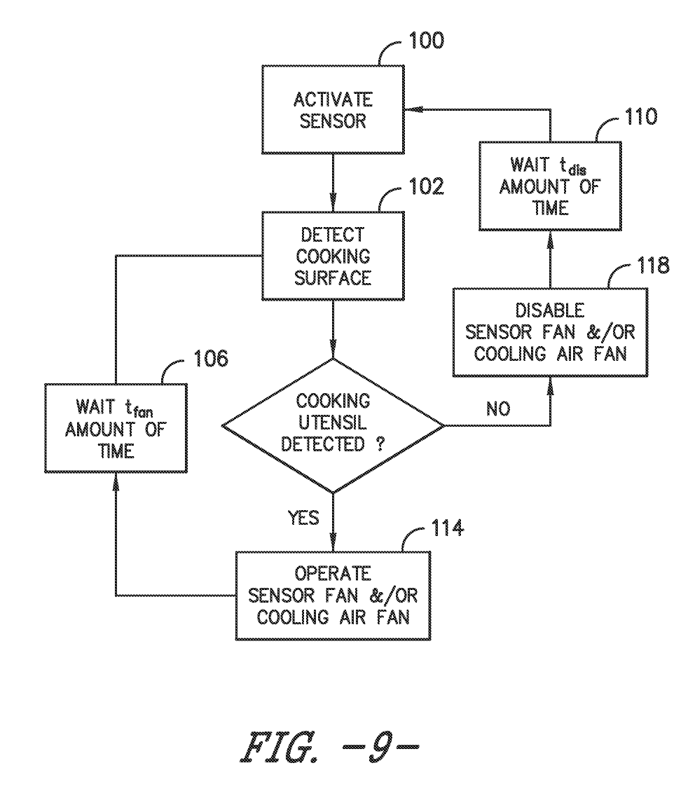

The present invention also includes embodiments where a sensor fan 80 is used in addition to fan 52 or instead of fan 52. Referring now to FIG. 9, for example, the present invention can include the step 100 of activating sensor 62 with controller 56, and the step 102 of detecting the cooking surface 30 to determine if a cooking utensil 28 is on cooking surface 30, as discussed above. Step 102 may be performed by the controller 56, e.g., by running a detecting algorithm. If a cooking utensil 28 is detected on cooking surface 30, the method includes the step 114 of operating fan 52, sensor fan 80, or both, to provide a flow of air F through channel 70 and past sensing end 78 of sensor 62, as discussed above. The method includes step 106 of waiting a programmed period of time t_{fan}. Step 102 may be repeated after step 106 to determine if the cooking utensil is still on cooking surface 30. If no cooking utensil 28 is detected on cooking surface 30, the method includes the step 118 of disabling fan 52 and/or sensor fan 80 and the step 110 of waiting a programmed period of time t_{dis} before reactivating sensor 62 to determine if a cooking utensil is present. In alternative embodiments, the method may include operating and disabling fan 51 rather than fan 52. In alternative embodiments, sensor fan 80 may be used in addition to fans 51 and 53 or instead of fans 51 and 53.

Additionally, microwave appliance 10 may include features, e.g., controls 26 or other suitable features, to allow a user of the microwave appliance to select the period of time t_{fan} and period of time t_{dis}. By way of additional example, controller 56 and sensor 62 may also be configured to operate fan 52 and/or sensor fan 80 only once a certain temperature on cooking surface 30 is detected.

The present invention is further directed to methods for signaling that sensing end 78 of sensor 62 has become contaminated and needs to be cleaned. As discussed, sensor fan 80, fans 51 and 53, and/or fan 52 may create a flow of air F to protect the sensing end 78 by blowing away, e.g., moisture, grease, or other contaminants generated during use of cooking surface 30 that might otherwise block or impede the proper operation of sensor 62. However, sensor fan 80, fans 51 and 53, and/or fan 52 may not prevent all contaminants from reaching sensor 62, such as, e.g., when sensor fan 80, fans 51 and 53, and/or fan 52 are not in use, and contaminants may build up on, e.g., sensing end 78 and impede operation of sensor 62. Thus, to maintain proper operation of sensor 62, sensor 62 may require cleaning to remove any contaminants built up on, e.g., sensing end 78.

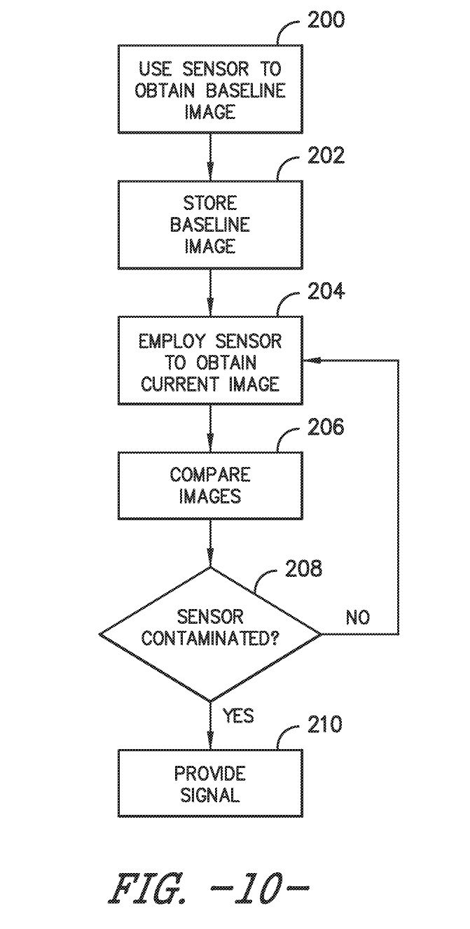

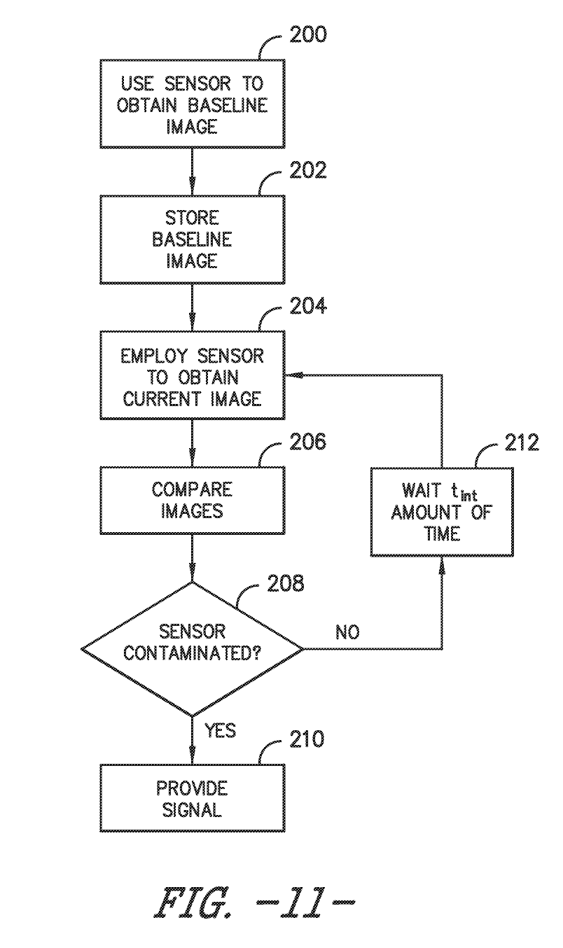

FIG. 10 illustrates one exemplary method for signaling that sensor 62 is contaminated and needs to be cleaned. The exemplary method includes step 200 of using sensor 62 when the sensor is in a known clean state to obtain a baseline image of cooking surface 30. At step 202, the baseline image is stored, e.g., by controller 56. The method also includes step 204 of employing sensor 62 to obtain a current image of cooking surface 30. At step 206, the current image is compared to the baseline image. The method further includes step 208 of determining, based on the comparison of the current image to the baseline image, if sensor 62 is contaminated and needs to be cleaned. Step 208 may be performed by controller 56, e.g., by running a background subtract algorithm, which subtracts the baseline image pixels from the current image pixels to identify, e.g., one or more differences or a magnitude of differences between the current image and the baseline image. If sensor 62 is determined to be uncontaminated, the method may return to step 204 and repeat steps 204, 206, and 208. Alternatively, as shown in FIG. 11, the method may include step 212 of waiting a programmed period of time tᵢₙₜ before repeating step 204. In still other embodiments, the method may return to step 204, e.g., when sensor fan 80, fans 51 and 53, and/or fan 52 are activated and/or disabled.

As shown in FIGS. 10 and 11, if sensor 62 is determined to be contaminated, the method includes step 210 of providing a signal to indicate contamination of sensor 62 to a user of the appliance. The signal may be, e.g., any audible and/or visual signal that indicates to the user that sensor 62 requires cleaning. By way of example, the signal may be a notification displayed on a user interface of the appliance, an LED light, a buzzer, and/or any other appropriate visual and/or audible signal.

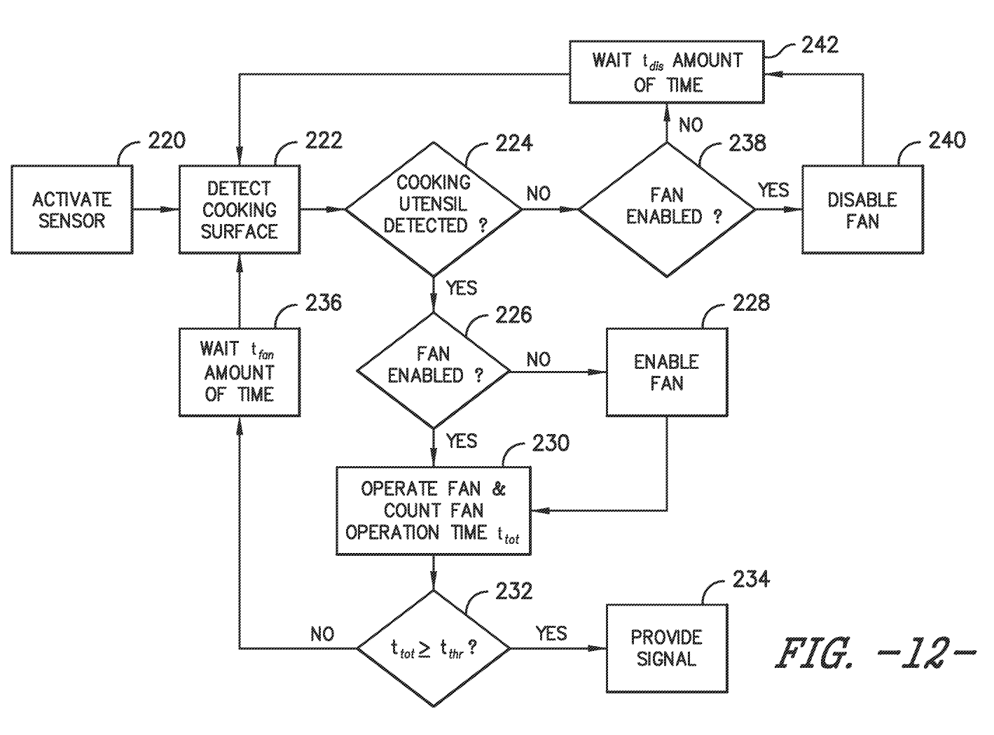

The present disclosure is also directed to other methods for signaling that sensor 62 is contaminated and needs to be cleaned. For example, the exemplary method illustrated in FIG. 12 includes step 220 of activating sensor 62, and step 222 of detecting the cooking surface 30, which may be performed by controller 56, e.g., by running a detecting algorithm. The method also includes step 224 of determining, based on the detection of the cooking surface, whether a cooking utensil 28 is on cooking surface 30. If a cooking utensil 28 is on cooking surface 30, the method includes step 226 of determining whether the sensor fan 80 is enabled. If the sensor fan is not enabled, the method includes step 228 of enabling sensor fan 80. At step 230, if enabled sensor fan 80 is enabled, or once sensor fan 80 is enabled, sensor fan 80 is operated to provide a flow of air F through channel 70 and past sensing end 78 of sensor 62, as discussed above. Also at step 230, the total operating time tₜₒₜ of sensor fan 80 is counted. The method further includes step 232 of determining if the total operating time tₜₒₜ of sensor fan 80 has reached at least a threshold value tₜₕᵣ, and if so, the method includes step 234 of providing a signal that sensor 62 requires cleaning. As discussed, the signal may be, e.g., any audible and/or visual signal that indicates to a user of the appliance that sensor 62 requires cleaning, such as, e.g., a notification displayed on a user interface of the appliance, an LED light, and/or a buzzer. Further, if at step 232 the total operating time tₜₒₜ of sensor fan 80 has not reached at least a threshold value tₜₕᵣ, the method may also include step 236 of waiting a selected period of time t_{fan} before repeating step 222 of detecting cooking surface 30 to determine if a cooking utensil 28 is present.

Moreover, if at step 224 no cooking utensil 28 is determined to be on cooking surface 30, the method includes step 238 of determining whether sensor fan 80 is enabled. If the sensor fan is enabled, the method includes step 240 of disabling sensor fan 80. If sensor fan 80 is disabled, or once sensor fan 80 is disabled, the method includes step 242 of waiting a selected period of time t_{dis} before redetecting cooking surface 30 to determine if a cooking utensil 28 is present. Additionally, as discussed, microwave appliance 10 may include features, e.g., controls 26 or other suitable features, to allow a user of the microwave appliance to select the period of time t_{fan} and period of time t_{dis}.

In alternative embodiments, sensor fan 80, fans 51 and 53, and/or fan 52 may be enabled and operated to provide a flow of air F through channel 70 and past sensing end 78. In such alternative embodiments, at step 230, the total operating time of sensor fan 80, fan 51, fan 53, and/or fan 52 may be counted to determine total operating time tₜₒₜ.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A method for operating a sensor of an appliance, the appliance supporting the sensor, the sensor being positioned over a cooking surface with a sensing end of the sensor directed toward the cooking surface, the method comprising the steps of:
employing the sensor to obtain a current image of the cooking surface;
comparing the current image to a baseline image;
determining, from the step of comparing, whether the sensor is contaminated and, if so, then
providing a signal to indicate sensor contamination to a user of the appliance.

2. A method as in claim 1, further comprising the steps of:
repeating the steps of employing, comparing, and determining if the sensor is found to be uncontaminated by the step of determining.

3. A method as in claim 1, further comprising the steps of:
waiting a predetermined time interval tᵢₙₜ if the sensor is found to be uncontaminated by the step of determining, and then
repeating the steps of employing, comparing, and determining.

4. A method as in claim 1, further comprising the steps of:
using the sensor to obtain an image of the cooking surface in a clean state; and
storing the image of the cooking surface in a clean state as the baseline image.

5. A method as in claim 1, wherein the step of comparing comprises executing a background subtract algorithm.

6. A method as in claim 1, wherein the step of determining comprises identifying one or more differences between the current image and the baseline image.

7. A method as in claim 1, wherein the step of determining comprises identifying a magnitude of differences between the current image and the baseline image.

8. A method for operating a sensor of an appliance, the appliance supporting the sensor, the sensor being positioned over a cooking surface with a sensing end of the sensor directed toward the cooking surface, the method comprising the steps of:
activating the sensor;
detecting whether a cooking utensil is on the cooking surface and, if so, then
operating a sensor fan configured to blow air past the sensing end of the sensor;
counting a total operation time tₜₒₜ of the sensor fan; and
providing a signal that the sensor requires cleaning when the total operation time tₜₒₜ reaches at least a threshold value tₜₕᵣ.

9. A method as in claim 8, further comprising after the steps of:
waiting a predetermined time interval t_{dis} if the step of detecting does not detect a cooking utensil on the cooking surface, and then
repeating the steps of detecting, counting, and providing.

10. A method as in claim 8, further comprising after the steps of:
waiting a predetermined time interval t_{fan} if the step of detecting does detect the presence of a cooking utensil on the cooking surface; and then
redetecting whether a cooking utensil is on the cooking surface and
continuing operation of the sensor fan if a cooking utensil is detected on the cooking surface; and
disabling the sensor fan if a cooking utensil is not detected on the cooking surface.

11. A method as in claim 8, wherein the sensor is an optical sensor.

12. A method as in claim 8, further comprising the step of:
selecting a time interval for t_{fan}.

13. A method as in claim 8, further comprising the step of:
selecting a time interval for t_{dis}.

14. An appliance, comprising:
a sensor having a sensing end, the sensing end downwardly directed toward a cooking surface of the appliance;
a sensor fan configured for creating a flow of air past the sensing end; and
a controller in operative communication with the sensor and the sensor fan, the controller configured for
employing the sensor to obtain a current image of the cooking surface;
comparing the current image to a baseline image;
determining, from the step of comparing, whether the sensor is contaminated and, if so, then
providing a signal to indicate sensor contamination to a user of the appliance.

15. An appliance as in claim 14, wherein the controller compares the current image to the baseline image by executing a background subtract algorithm.

16. An appliance as in claim 14, wherein the controller determines whether the sensor is contaminated by identifying one or more differences between the current image and the baseline image.

17. An appliance as in claim 14, wherein the controller determines whether the sensor is contaminated by identifying a magnitude of differences between the current image and the baseline image.

18. An appliance as in claim 14, wherein the sensor fan is operated when the sensor detects a cooking utensil on the cooking surface.

19. An appliance as in claim 14, wherein the controller further is configured for
waiting a predetermined time interval tᵢₙₜ if the sensor is found to be uncontaminated by the step of determining, and then
repeating the steps of employing, comparing, and determining.

20. An appliance as in claim 14, wherein the controller is further configured for
using the sensor to obtain an image of the cooking surface in a clean state; and
storing the image of the cooking surface in a clean state as the baseline image.
